(19) United States
(12) Patent Application Publication
(10) Pub. No.: US 2010/0112307 A1
(43) Pub. Date: May 6, 2010

(54) Metallized insulative labeling material

(76) Inventor: Gary Duncan, Fairport, NY (US)

Correspondence Address: HEDMAN & COSTIGAN P.C., 1185 AVENUE OF THE AMERICAS, NEW YORK, NY, 10036, US

(21) Appl. No.: 12/454,100

(22) Filed: May 12, 2009

Related U.S. Application Data
(60) Provisional application No. 61/197,900, filed on Oct. 30, 2008.

(51) Int. Cl. B32B 3/26; B32B 3/10

(52) U.S. Cl. 428/195.1; 428/304.4; 428/319.1

(57) ABSTRACT

A packaging structure having at least one layer of a foam component and at least one metallized layer wherein the layer enhances the insulating effect of the foam and provides a bright, attractive finish to a label or package. The metallized layer is preferably provided on its outer surface with a a reverse printed film.

### CROSS-REFERENCE TO RELATED APPLICATIONS

This application claims the priority of Provisional Application Ser. No. 61/197,900, filed Oct. 30, 2009.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### REFERENCE TO A MICROFICHE APPENDIX

Not Applicable

### BACKGROUND OF THE INVENTION

1) Field of the Invention

This invention relates to the insulation and labeling of packaging.

2) Description of Related Art

The reflective characteristics of a metallized surface have long been recognized as having benefits with respect to providing insulation as the outer sheath in layered insulation used in the construction industry. Additionally, a metallized glass surface enhances the insulative effects of two ply vacuum sealed glass containers such as the well known Thermos™ Bottle. This invention seeks to utilize this well established principle to generate a unique metallized foam packaging and label material, in which both the insulative and decorative impacts of the foam are enhanced by provision of a bright, reflective metallized outer layer. The particular aspects of the labeling and packaging materials envisioned lend themselves to conformable labels, labels for straight-walled containers, and general packaging applications.

Multilayered jackets for covering containers, containing a metallized, insulated foam as an inner layer of the structure disclosed in U.S. Pat. No. 4,871,597 of Michael Hobson. The jacket is light-weight, collapsible and removable. An insulating jacket for a beverage container is also disclosed in U.S. Pat. No. 4,462,444 of Fred Larson, assigned to Pocket Cooler Company.

The jacket includes an outer cover and an inner liner with a resilient insulating material there between. The jacket is sewn at the ends and provides a resisting mechanism which assures a tight fit when a beverage container is inserted into the jacket. In U.S. 2003/0207059 A1, Benim, et al, addressed to E.I. duPont de Nemours and Company discloses an insulating label stock which can be wrapped around a can, imparting both insulating properties and printing capability to a container. The structure includes a polyester fiber material, sandwiched between layers of polyester film.

These prior art disclosures while broadly addressing the objective of providing insulation to a container, do not provide the ability to address a broad segment of the labeling and packaging market due to their highly specialized functionality and prohibitive costs.

In addition, only the Benim et al. disclosure is for a label per se. The Benim et al disclosure lacks the decorative and functional impact of the addition of a metallized layer to the insulating structure and requires a separate layer of labeling material to be added and shrunk to the container to achieve the desired functionality. The result is a very costly label limited mainly to specialty/promotional applications.

### SUMMARY OF INVENTION

The present invention provides a packaging structure comprising a foam component and at least one metallized layer, preferably on the exterior surface of the structure. The metallized layer of the packaging structure enhances the insulating effect of the foam and provides a bright, attractive finish to the label or package. The packaging structure can be used either as an unsupported package, a jacket for use on hot or cold beverage containers or as a label, an insulative tape, or outer wrap for use on rigid containers which, enhances the insulative and decorative aspects of primary packaging materials, as well as other applications where the decorative and insulative features improve the appearance and/or insulating characteristics of the total package. The term comprising is used herein to describe a structure which may have other components in addition to the recited components. The invention may also consist essentially of a packaging structure comprising a foam component and at least one metallized layer, preferably on the exterior surface of the structure where the term “consists essentially of” means that no other component may be present that materially changes the structure.

It is a primary object of the invention to provide an insulating structure which has a bright, reflective metallized surface on the exterior where the structure is adapted for use as a packaging or labeling material.

It is also an object of the invention to provide an insulating structure which may be used as a label per se on hot or cold beverage containers. These and other objects of the invention will become apparent from the present specification.

It is also an object of this invention to provide a structure having high durability, that may be utilized as a highly decorative, metallized, insulative packaging and labeling material which utilizes extruded foamed polystyrene, polyethylene, polypropylene, or polyester or other foamed polymer as a base which optionally can be shrunk to the contours of a container or utilized in a non-shrink mode as a label or packaging material.

### BRIEF DESCRIPTION OF THE SEVERAL VIEWS OF THE DRAWINGS

FIG. 1a is a sectional view of a directly metallized foam which can be employed as an insulating foam label or packaging material.

FIG. 1b is a sectional view of a laminate made with a transfer metallized, insulating foam label or packaging material.

FIG. 1c is a sectional view of a typical surface printed coextruded and directly metallized foam which can be employed as an insulating foam label or packaging material.

FIG. 1d is a sectional view of a typical laminate employing surface printed metallic, film laminated to an insulating foam label or packaging material.

FIG. 2 is an elevational view of a beverage can onto which the metallized, insulating foam label has been applied and shrunk to the contours of the container.

FIG. 3a is a line drawing showing a process flow diagram which depicts a central impression flexographic printing and laminating process in which the label material or packaging material is converted into a printed, functional form. The metal transfer and laminating portions of the process are shown as outboard stations to the central impression printing drum. The last press station is assumed to apply an adhesive which is used to transfer the metal from the outboard transfer nip shown in the drawing.

FIG. 3b is a process flow diagram showing a modular press, such as a rotogravure press, modular flexographic press, or offset lithographic press equipped with stations for transfer metalizing to the back of the printed web and laminating to the foam. An alternative method, not shown, would be to coat the foam with an adhesive and transfer the metal to the foam, prior to finally laminating the foam to the printed film. The use of radiation cure technology for both the printing and adhesive coating steps in the process simplifies the line and reduces the amount of space required by eliminating the requirement for the large dryers which are employed in the conventional hot air convective dry processes.

FIG. 4 is a graph which provides a comparison of the heat gain from an aluminum can labeled with a metallized foam laminated structure to both an un-metallized labeled foam labeled container and an un-labeled, direct printed can. The can was filled with water, cooled in a refrigerator, then placed in a near constant temperature environment maintained at summer temperature conditions of 84.4-85.7° F. and temperature gain was measured as a function of time for a period of 1 hour in 5 minute increments.

FIG. 5 is a graph showing the heat transfer coefficient for free convection for the aluminum cans from the same test displayed in FIG. 4. The heat transfer coefficient was calculated using Newton's equation for free convection; q=kAdT, where:

q=heat transferred/unit time

A=heat transfer area

K=convective heat transfer coefficient w/m²-° C.

dT=temperature difference between the surface and the bulk fluid

### DETAILED DESCRIPTION OF THE INVENTION

The foam used can be a classical open-cell or closed-cell foam formed by gas injection, chemical blowing agents, or by cavitation utilizing known formulating technology employed with oriented films, and can be a mono-layered product, a co-extruded product having a discreet, filmic layer and a foamed or cavitated layer, or a laminate in which a filmic layer(s) is combined with the foamed layer or co-extruded film/foam. Closed-cell foams are preferred because they do not imbibe large quantities of water as do open-cell foams and in addition closed cell foams have a more uniform structure. The metallized layer can be achieved by any one of the known means of adding this feature, including direct metallization of the coextruded outer skin surface of the foam, transfer metallization of either surface of the coextruded foam, transfer metallization of a mono-layered foam, metallization of a printed outer film, or lamination of a printed or unprinted metallized film surface to the foam.

The preferred foam structure, used in the invention, will have a smooth, high gloss metallized outer surface, although the inner surface of the structure may contain an additional metallic or polymeric film layer to allow ease of application to a container when the structure is placed on a container by sliding the structure over the container. The usual means of generating a metallized surface is direct metalizing of the surface in a vacuum chamber. The metal, usually aluminum, is gasified using high energy electrical arc in vacuum. The gasified metal then condenses directly on the film surface as it traverses past the evaporation sources, which are aligned transversely across the moving film web. Generally, the metallized film will be from 50 to 400 Å, and preferably from 100 to 200 Å thick It has been found that coextrusion of a smoother, outer surface onto the foam provides a surface which results in a high gloss metallized surface. Of particular utility are a class of polystyrene-butadiene copolymers marketed as a class and trade-named “K Resin”, supplied by CP Chemicals (Chevron-Phillips). In order to achieve a high level of adhesion of the metallized layer, we have found it necessary to utilize an oxidative treatment on the coextruded film surface of the foam. Such treatment is commonly practiced in the industry and can either be achieved by a flame treatment or corona discharge treatment of the film side of the foam.

The metallized foam thus provided can be further converted either through surface printing, providing necessary graphics for commercial packaging or labeling applications. Typically, high durability surface over-lacquers would be utilized to improve the durability of such a sheet. Alternatively, the metallized foam can be laminated to a printed outer layer of filmic material. Should a transparent web be used as the outer layer of the laminate, the web would be preferably printed on the reverse side, thus achieving buried print and buried metal within the laminate, thus exhibiting excellent durability.

As an alternative to the use of the “K resin” skin on the foam, it has been found that transfer metalizing of the foam surface or of the coextruded film skin also can provide a bright, metallic finish to the foam. In this instance, the metallized surface tends to take on the finish of the substrate on which it is first metallized, rather than the finish of the foam itself. As a consequence, we have found that while a smooth, coextruded outer surface lends itself to excellent metallization results, transfer metalizing to the foam itself, especially when the metallization is applied to the smoother side of the foam, indeed can also provide a good result, without the cost factors associated with the coextruded filmic which is metallized on the coating side, then laminated to the receiver sheet (in this case the foam or previously printed film). The receiver sheet (or optionally the metallized transfer sheet) is coated with an adhesive coating which is dried, then brought together in a nip with the transfer sheet, bringing into contact the metallized side of the transfer sheet and the receiver sheet to accomplish a lamination of the two sheets. Then, either in a separate operation or downstream of the combining nip, the two sheets are stripped apart, the metal having been thus transferred to the receiver sheet. The transfer selvage roll is wound and in some processes can be reused. A particularly economic means of achieving metallization in this way is to utilize the non-polar surface of an untreated, oriented polypropylene sheet as the transfer web, thus eliminating the need to coat the transfer web, the non-polar surface easily releasing the metal in the transfer nip. This sheet when properly handled and wound as the selvage roll can be re-used many times, reportedly as many as 20 trips through the vacuum metalizing process.

Another means of achieving a metallized surface on the foam structure is to utilize the outer ply of the lamination as a means of providing the metallized surface. Here, an outer ply is typically printed on the reverse side, an outer, metal receptive coating layer is then applied over the inks on-press. I have found that the Michemprime 4990R, from Michelman Chemical, Cincinnati, Ohio, is especially useful as a metal receptive coating applied over inks. This material is an aqueous dispersion of ethylene-acrylic acid and is typically applied at less than 0.2 gm/msi in order to achieve good metal adhesion. This thin film structure is then metallized in a vacuum chamber, obviously in an out-of-line operation. The metallized structure is then laminated to the foam in a separate operation.

The overall structure provides both buried printing and metallization, thus exhibiting excellent durability. An alternative to the out-of-line, separate operation required by direct metallization of the printed outer web of the laminate would be to transfer metallize either the printed web or alternatively the foam in-line with the printing operation, as earlier indicated. This fully integrated process would then require two lamination steps to be performed in-line, one to transfer the metal and one to laminate the outer film to the foam.

An additional means of providing the metallized surface for the foam lamination is to utilize a separate, metallized sheet as part of the overall structure. Here the previously metallized sheet can optionally be surface printed directly onto the metal or on the reverse side of the metallized sheet, with a protective coating applied over the print, then laminated to the foam. It is also possible to provide the printed web as a totally separate outer web of the laminate, laminating first to the metallized sheet, and next laminating to the foam sheet, thus providing a three ply laminate.

The structure according to the invention optionally can be used for container labeling or packaging applications. A sleeve formed from the sheet can optionally be seamed in-line with the labeling operation, utilizing either solvent, heat sealing means, hot air, ultrasonic seaming, or laser seaming to provide a full 360° coverage of a container, which will typically be a metal can or a glass or plastic bottle. The label so achieved provides improved insulation properties to the container over that achievable by the container materials themselves, thus providing the consumer with a longer time to enjoy a hot or cold beverage or the like. When the structure is used for hot drinks, the added insulation of the label provides for a lengthened time for the hot beverage to cool. A particularly desirable aspect of the invention is the ability to utilize the material as a shrink label which can conform to the contoured shape of the container.

The structure can also be utilized as a primary packaging material and formed into pouches or used to overwrap packages, thus providing improved thermal insulation protection to the package as well as carrying the graphics for display of the product. The metallized appearance of the product provides a very attractive appearance which adds to the shelf-appeal of such products while providing improved thermal protection.

The foam component can be provided by a number of alternative technologies. including technology disclosed in the examples of U.S. Pat. No. 4,463,861 issued to Tsubone and Machida and assigned to Sekisui Kaseihin Kogyo Kaisha, which are incorporated by reference,. That foam is a polystyrene based foam which is preferred for use as the coextruded foam component of the lamination. Non-coextruded, single layer foams can be utilized in all aspects of the invention save that of direct metallization of the foam. The utilization of alternative polystyrene foams from alternate sources as well as alternative polymer foams which provide a similar insulative function all fall within the spirit and scope of this disclosure.

Both direct metallization of the coextruded polymer skin surface of foamed polystyrene and transfer metallization of both the foam surface and the coextruded film surface of the foam have been used to demonstrate the performance of the invention. In direct metallization of the foam, the surface smoothness of the coextruded film skin has been shown to control the brightness of the resultant metal surface. Insulation studies to evaluate the effect of metal brightness on the effectiveness of the insulation have shown that a brighter surface provides somewhat improved insulation vs. that of a duller, more matte finish surface, although both surfaces are shown to provide improved insulation properties vs. that of the same material un-metallized.

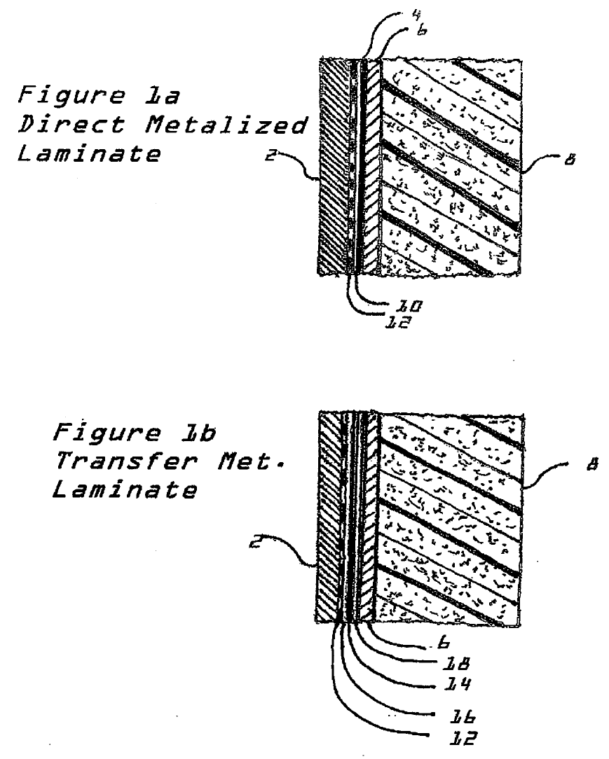

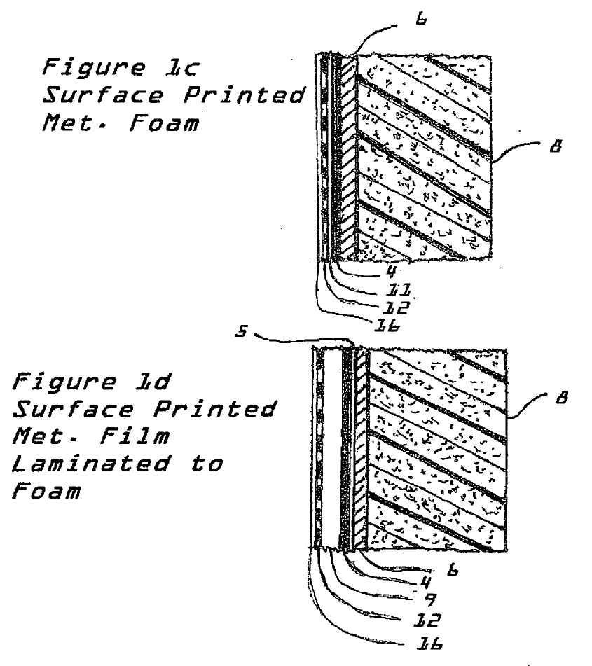

FIG. 1a is a sectional view of a coextruded and metallized foam which can be employed as an insulating foam label or packaging material. Here the foam layer 8 has a coextruded film skin 6 which may be high impact polystyrene on which is placed a directly metallized layer 4 on which a layer of adhesive 10 is placed. Adhesive layer 10 is laminated to film layer 2 having reverse printed indicia 12.

FIG. 1b is a sectional view of a coextruded and metallized foam which can be employed as an insulating foam label or packaging material. Here the foam layer 8 has a coextruded high impact polystyrene film skin 6 in contact with adhesive layer 18 which is in contact with a transfer metallized metal layer 14. The metal layer 14 has an adhesive layer 16 which is laminated to film layer 2 having reverse printed indicia 12.

FIG. 1c is a sectional view of a coextruded and metallized foam which can be employed as an insulating foam label or packaging material. Here the foam layer 8 has a coextruded high impact polystyrene film skin 6 with a directly applied metal layer 4. Layer 11 is a print receiving layer which is directly printed with indicia 12 which is overcoated with a protective lacquer layer 16.

FIG. 1d is a sectional view of a coextruded and metallized foam which can be employed as an insulating foam label or packaging material. Here the foam layer 8 has a coextruded high impact polystyrene film skin 6 with an adhesive layer 5. Layer 5 is laminated to a composite of directly metallized layer 4 on a film base 9 such as polypropylene which has printed indicia 12 which is overcoated with a protective lacquer. Any surface that bears printed indicia would typically be in-line coated with a print receptive primer coating such as MichemPrime 4990R, an ethylene-acrylic acid dispersion available from Michelman Chemical, Cincinnati, Ohio, prior to being printed with highly decorative multicolored graphics. Finally a solvent base protective overlacquer such as Flint Flexcon polamide resin/wax available from Flint Inks, Ann Arbor, Mich., is coated directly over the printed surface. The coating level normally used for protective top lacquers of this sort is about 1-2 gm/msi (dry), from an ethyl acetate/n-propyl alcohol solution. All these operations are preferably done in-line with the printing step; however, they can be done out-of-line in separate operations. In the alternative, other conventional surface treatments such as a corona treatment may be used to provide a print receptive surface where necessary.

Direct metallized surfaces are highly reactive and tend to form metal oxides due to contact with the air. Protective packaging is typically used to limit air contact with freshly metallized surfaces, but storage of freshly metallized product more than just a few weeks many-times results in an oxidized metal surface which is difficult to get inks to adhere to. A protective surface lacquer such as “C” Type nitrocellulose, available on the open market from many suppliers, may be applied typically at less than 0.2 gm/msi from an ethyl acetate/n-propyl alcohol solution onto a freshly metallized surface to prevent this oxidation. Alternatively, specially modified corona treating rolls (modified to allow for a conductive substrate) can be used to clean the metal surface. Additionally, a print primer can be applied in-line to the metal surface prior to application of the printing inks. The Type C nitrocellulose can be used with many inks, but other primer coats such as MichemPrime 4990R, described earlier or radiation curable coatings can also be used, especially where in-line corona treatment is employed. The chemistry of many of these primer systems may vary widely, such as urethane, nitrocellulose, polyamide or acrylic based compounds available through many specialty coating suppliers, such as Henkel North America, National Adhesives, S. C. Johnson, Michelman Chemical, Flint Ink or Environmental Ink Company. In some instances, a co-reactant can be optionally be added to cross-link polyamide or epoxy based coatings and provide even harder, more resistant protection of the ink. Typically the co-reactant added (such as polyfunctional aziridene) is 1% or less, based upon the dry weight of coating.

In the case where the outer film ply is first printed, a protective, receptive lacquer is applied over the inks in order to achieve good metal adhesion. This lacquer can be either solvent based such as the Flint Flexcon or water based such as the PD65924 from Process Resources or a radiation cured coating, such as Flint Ink UVB01002. Good adhesion to the metal layer tends to be a function of having a high number of bonding sites on the coating and having a smooth, clean surface to adhere to. If the metallization is to be done in an out-of-line operation, the coatings must be formulated not only to provide adhesion to the metal layer, but also to allow winding and subsequent unwinding of the printed film in the metalizing chamber without back to front blocking of adjacent layers of the film. Acrylic based coatings, usually emulsified and formulated with small amounts of anti-blocking agents (at concentrations low enough not to interfere with metal adhesion) can be used. The PD65924 product is also useful for this application for many ink systems. In some instances, some experimentation by the printer will be required in order to acquire a coating which is compatible with the specific ink system in use.

This process can be simplified if the printing and lamination process includes an integrated metal transfer step. Here, since the metal is being transferred directly to either the printed film or the foam in-line with the printing, there is no need to formulate the print overlacquer for anti-blocking characteristics. The material needs only to adhere to the metal layer, hence a conventional adhesive coating, either pressure sensitive or dry bonding, depending upon the process employed, can be used. A pressure sensitive adhesive effective in accomplishing a quick bond to allow efficient metal transfer such as the solvent based Dow UCAR 185RG, applied at a dry coating weight of 3-4 gm/msi has been found effective. Dry bond adhesives such as the Purethane C1004, available from Ashland Specialty Chemical have also shown utility for non-shrink applications. These adhesives are optionally used with a co-reactant such as polyfunctional aziridine at levels up to 1%. A dry-bonding style adhesive would require a heated roll at the transfer nip to be employed, whereas a pressure sensitive adhesive would allow an unheated roll to be used in the transfer nip.

The outer print layer for laminated structures can be any number of materials, depending upon the specific application for which the product is to be used. For non-shrink applications, the listing of potential film printing bases is expansive, including biaxially oriented polypropylene, cast polypropylene, monoaxially oriented polypropylene, monooriented and biaxially oriented polystyrene, polyethylene, vinyl, polyethylene terephthalate (PET) polyester films, and other less common polymers. For shrink applications, the listing of potential films becomes more limited and specific. We have found for moderate shrink applications that a number of film options tend to work well, including preferential machine direction shrink oriented polypropylene films, machine direction shrink polystyrene based products, machine direction shrink vinyl products.

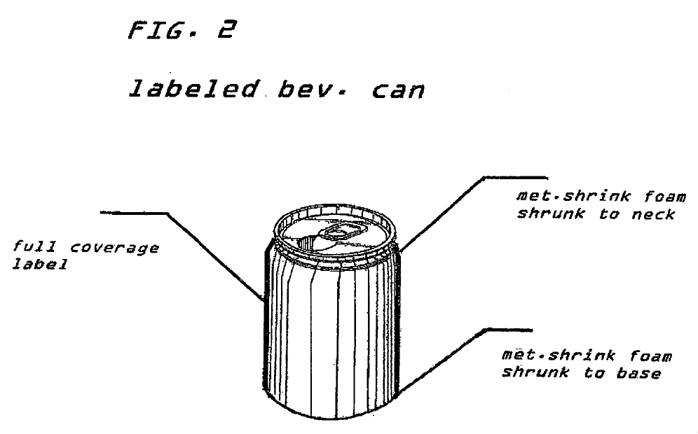

FIG. 2 is an elevational view of a beverage can onto which the metallized, insulating foam label has been applied and shrunk to the contours of the container. The foams used were Commodore Plastics Labec™ products which had been produced using a specialized, machine direction orientation technique and then metallized. The material tends to shrink principally in the machine direction, with very little or no shrink in the cross-direction. While the material has the capacity to shrink as much as 50% or more in the machine direction, typically for necked in beverage cans and the like only 10-12% shrinkage is required, which is easily achieved by the product.

It has been found that the shrink force exerted by the outer ply of the lamination must be carefully controlled in order to avoid forming “cold wrinkles” as the label is shrunk to the container. “Cold wrinkles” form between the skin layer and the foam layer. The foam layer is held in place against the cold container and the skin layer tends to shrink faster than the adjoining foam due to the fact that the heat is being applied from the exterior, skin side of the product. The shrinkage of the skin tends to create shearing forces acting against the adjoining foam. The result is a bunching of the foam due to this shearing effect. The relatively small amount of shrink required by typical necked-in beverage cans tends to limit this undesirable effect, but utilization of relatively slow shrinking, low shrink tension materials are recommended in order to limit this undesirable affect upon the appearance of the shrunk label.

Moderate shrink, preferentially machine direction oriented polypropylene films, specially formulated oriented polystyrene films and the like are preferred as the film component of the lamination. The addition of polyethylene or rubber containing compounds to lessen the shrink rate of the outer layers, as taught in the Examples of U.S. Pat. No. 4,626,455 to Karabedian or U.S. Pat. No. 4,463,861 to Tsubone and Machida, which are incorporated by reference, may be employed to lessen the orientation of the outer layers.

The brilliance of the metallized layer in the sections of the container where the label is shrunk will deteriorate depending upon the extent of the shrinkage. As before noted, the brilliance of the metal is important with respect to maximizing the insulative effect of the foam label. For the small shrink area involved in necked-in cans, this impact is minimal, but for bottles or other containers with larger contours requiring shrink, we have found that the addition of metallized inks over the shrink areas tends to enhance the metal brilliance and resultantly improves the overall insulative properties of the label.

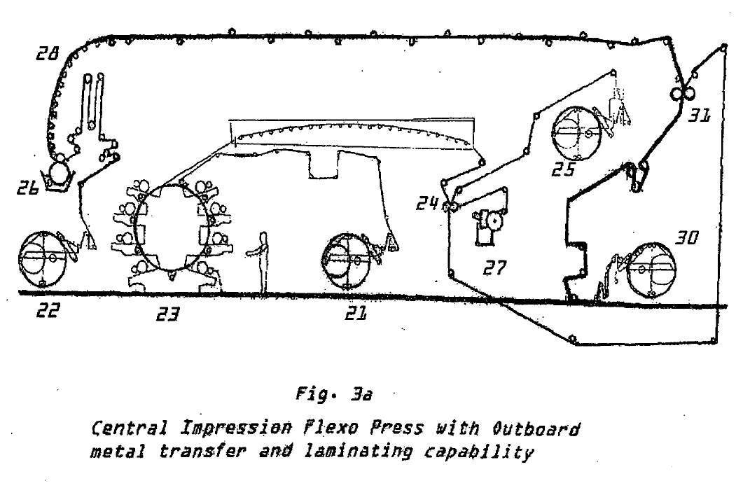

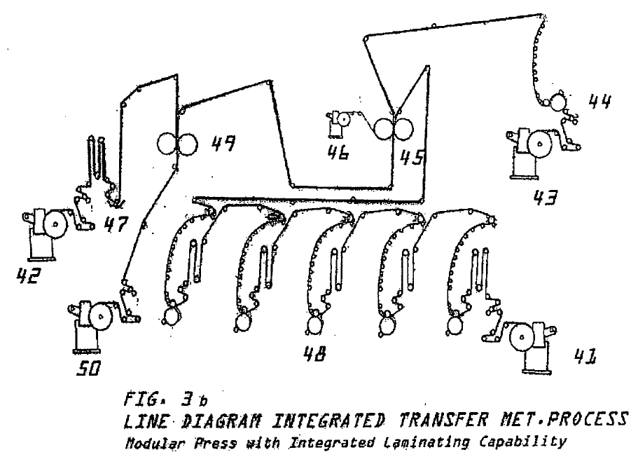

FIG. 3a is a line drawing showing a central impression flexographic printing and outboard laminating process in which the label material or packaging material is converted into a printed, functional form. In this drawing, I have shown the fully integrated process in which the outer web is printed on the reverse side, then transfer metallized on the primer coated surface of the print layer, then laminated to the foam. The film side is printed with as many as 4-10 colors, then the print layer is over-coated with a receptive primer coating detailed earlier, typically an acrylic based pressure sensitive coating applied either from a solvent, or emulsion base or utilizing a radiation curing means.

The particular process shown in the drawing is for a coating requiring a dryer oven to dry and cure. Here, for shrinkable film stocks, care must be taken to maintain the drying oven at temperature below that which will begin shrinking the film. In this instance, the oven temperature is typically maintained in the 120-150° F. range. The printed film next is brought into contact with the metal transfer web in a nip roll assembly. If the primer used is a pressure sensitive coating, the rollers used are at ambient conditions. If the primer used requires heat activation, a heated steel roll is used in the nip to activate the adhesive and accomplish the transfer. For shrink labels, due to the inherent temperature sensitivity of the films used, a pressure sensitive adhesive is normally used in combination with the unheated transfer nip. After transfer of the metal layer, the spent transfer film is rolled for re-use on a selvage winder.

Next in the process, the transfer metallized printed film is coated with a laminating adhesive. Again, as was the case above for shrinkable films, the laminating adhesive used is typically a pressure sensitive acrylic which after drying allows the adhesive to be mated to the foam in a nip operating at ambient temperature. I have found the UCAR 185RG, applied at a dry coating weight of 3-4 gm/msi to be useful. For non-shrink films, again a dry bonding adhesive such as Ashland's Purthane C1004 requiring hot roll temperatures as high as 220° F. for bonding can be used. The transfer metallized film then is brought into contact with the foam component and the final laminate is formed. As was indicated earlier, an alternative and equivalent process would allow the foam to be coated with the transfer adhesive, then brought into contact with the printed web to accomplish the lamination.

The foam alternatively can be pressure sensitive coated and laminated to a release liner in an out-of-line operation. The release liner from the pressure sensitive coated foam can be removed on-press, then the pressure sensitive adhesive surface brought into contact with the printed web to accomplish the lamination. This process requires the pre-lamination of the foam as a pressure sensitive construction and requires the discarding of the relatively expensive release liner, thus is a more expensive alternative.

FIGS. 3a and 3b are process flow diagrams which illustrate a procedure for producing the invention on a large scale. FIG. 3a utilizes a film unwinder 21, from which the film is passed to a central impression press 23 where it is printed with indicia and passed to print dryer 29. After drying, the printed film is laminated to a metal layer at metal nip 24 which is provided with a layer of metal from metal unwinder 25. The foam layer is unwound at unwinder 22 and coated with adhesive at adhesive coating station 26 and then passed to dryer 28 from which it is passed to lamination station 31 where the printed film is laminated to the adhesive coated foam. A selvage winder 27 is used to collect selvage from the metal transfer nips 24.

FIG. 3b discloses a process flow diagram where the meal layer is provided in a transfer metalizing step. The film is passed from film unwinder 41 to a series of modular presses for the application of multicolor indicia. The printed film layer is then transfer metallized at transfer metalizing nip 45 where the selvage is rolled on selvage rewinder 46. The metal transfer film is unwound at unwinder 43 and coated with adhesive at coating station 44. The metallized printed film is laminated to the foam which is passed from the foam unwinder 42 and adhesively coated at foam adhesive coating station 47. The laminated final product is passed to winder 50 where it formed into rolls for shipping.

The process may utilize a modular press, such as a rotogravure press, modular flexographic press, or offset lithographic press equipped with outboard stations for transfer metalizing to the back of the printed web and laminating to the foam. The modular arrangement described in FIG. 3b, allows for the addition of modules at the end of the press to do the metal transfer and the laminating operations, rather than providing them in outboard stations as shown in FIG. 3a . Further simplification and significant reduction in the overall size of the process can be achieved through the use of radiation cure inks and adhesive coatings. The use of either UV cure inks and coatings or electron beam cure inks, coupled with UV cure coatings dramatically reduces the overhead space required for the process by eliminating the large dryers required by conventional convective air or infra-red drying.

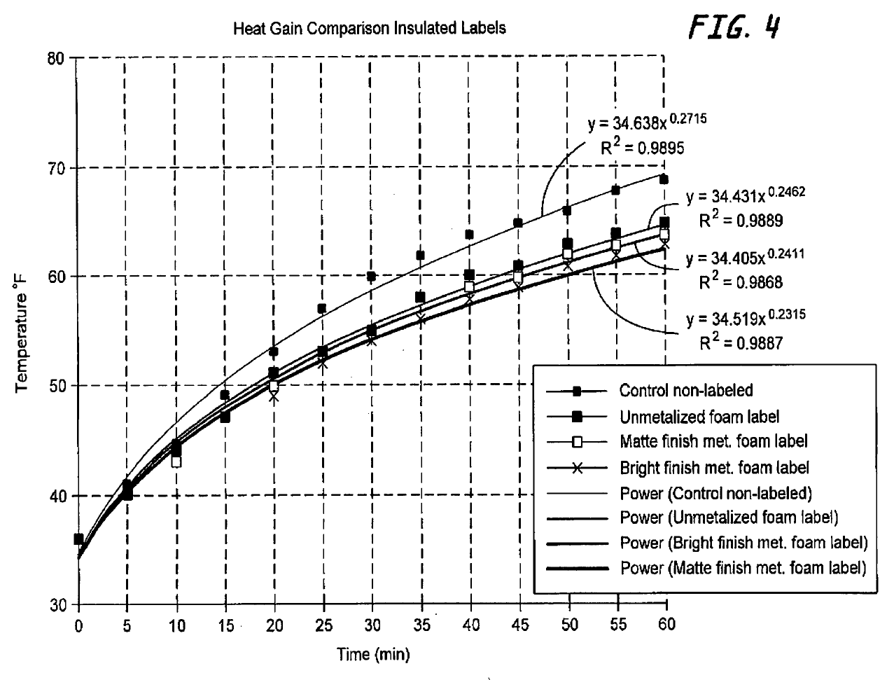

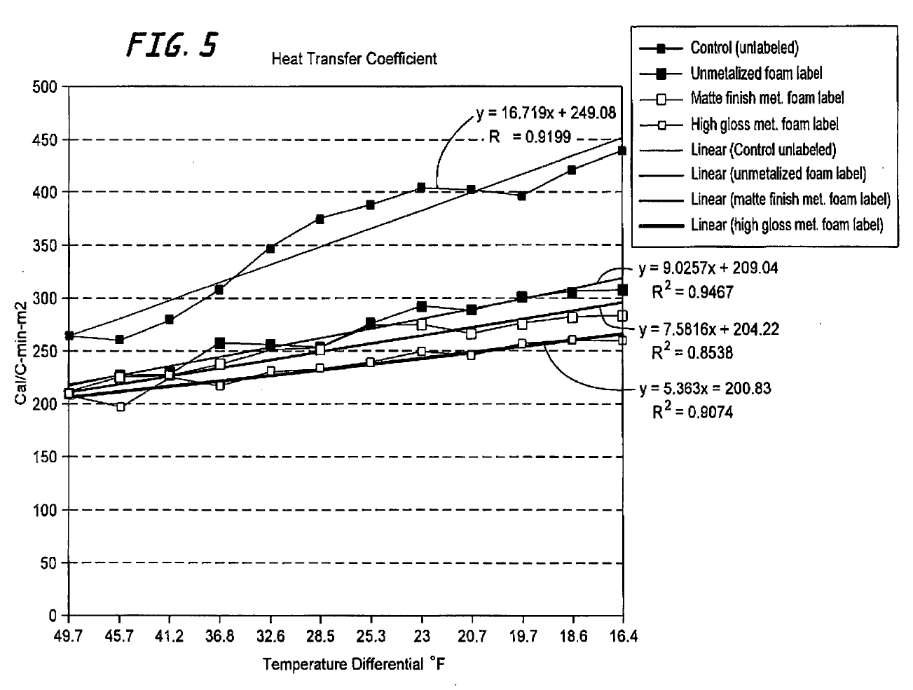

FIG. 4 is a graph which provides a comparison of the heat gain from an aluminum can labeled with a metallized foam laminated structure to both an un-metallized labeled foam labeled container and an un-labeled, direct printed can. The can was filled with water, cooled in a refrigerator, then placed in a near constant temperature sunlit, and partially shaded environment maintained at summer temperature conditions of 84.4-85.7° F., Temperature gain was measured as a function of time for a period of 1 hour in 5 minute increments. Comparing the time for the labeled container to reach a temperature of say 60° F., which is still cool and a pleasing temperature for drinking cool beverage, the non-metallized foam label keeps the temperature below this level for a period of roughly 10 minutes longer than the unprotected can, the matte finish metallized foam adds an additional 3 minutes to this time (totaling 13 min.), and the bright finish metallized foam label adds an additional 9 minutes over that of the matte finished metallized label, totaling 22 min. longer time to reach 60° F., thus significantly adding to the time that the beverage can be enjoyed.

FIG. 5 is a graph showing the heat transfer coefficient for free convection for the aluminum cans from the same test displayed in FIG. 4. The heat transfer coefficient was calculated using Newton's equation for free convection; q=kAdT, where:

q=heat transferred/unit time

A=heat transfer area

K=convective heat transfer coefficient w/m²-° C.

dT=temperature difference between the surface and the bulk fluid

Newton's equation was integrated using the following relationships:

Q=∫(t₁to tₘ)dq/dt=Cₚm (delta)t=kA∫(TₐtoT)

Where:

Q=heat transferred/5 min interval

t₁=starting temperature of the fluid at the beginning of the time interval (5 min.)

tₘ=ending temperature of the fluid at the end of the time interval (5 min)

Cₚ=heat capacity of water=1 cal/gm° C.

m=mass of fluid in gm.

k=convective heat transfer coefficient cal/m²-° C.-min

A=exposed area of the container (sides+top)m²

Tₐ=ambient temperature

T=temperature of fluid at the start of the measuring period=t₁

Solving the equation for k:

k=Cₚm t A∫(TₐtoT)

the solution to the equation is approximated by taking small increments of time and approximating the integral by averaging over the entire time-span of the test. The equation used for each 5 minute increment is as follows:

k=Cₚm(t^{5min}−t^{o})/A((T^{ambient}−(t^{5min}−t^{o})/2); where

Cₚ=heat capacity of water=1 cal/gm/° C.

A=exposed area of a 12 oz. beverage container (sides+top)=41.7 in²(0.0269 m²)

m=12 oz water=340.2 gm.

This invention depends not only upon the presence of a metallized layer on the foam, which enhances the overall insulation effects of the structure, but also is vitally dependent upon the insulation added by the foam itself. In this invention, a coextruded, two layered plastic sheet containing a principal foamed polystyrene layer and a thin cap layer was first formed in a continuous operation into a finished roll of product using the examples of Tsubone and Machida, in U.S. Pat. No. 4,463,861, which are incorporated by reference. The particular extrusion system employed utilized two extruders, a principal extruder having a screw diameter of 3½″ and a smaller secondary, cooling and metering extruder having a screw diameter of 2½″ to form the foam segment of the web. The thickness of the foam layer may be from 0.1 to 0.5 mm and more preferably from 0.125 to 0.375 mm, and especially preferably about 0.15 mm. A single or multilayer foam layer may be utilized in the invention

The principal extruder functions to melt the polystyrene polymer. Then gas is injected at the forward (melt) end of the extruder, where the mix of gas and polymer melt is injected into the feed section of the secondary extruder. In the secondary extruder, the gas is mixed thoroughly with the foam as it is cooled to form a controlled density foam at the exit of the extruder which exits into a feed block which ultimately flows into an annular die. The polymer mix used in the foam extrusion contains a third component known as a “nucleating agent” which acts to provide sites for the injected gas to initiate uniform formation of a stable, closed cell foam.

A third extruder (2″) is used to extrude a film cap layer onto the outer surface of the foam layer. The actual mating of the cap layer and the foam takes place in the feed block which leads into the flow channels which feed into the annular die, as shown in FIG. 2 of U.S. Pat. No. 4,463,861, which is incorporated by reference:

The foam polymer stream from the secondary extruder (3) and the extruder for the non-foamed film (4) are combined in a meeting zone known as a combining block (5), whereby the resin for forming the non-foamed film (2) encircles the resin for forming the foamed film (1). The combined flow of the resins progresses to a die head (6) having an annular slit to allow inflation of the bubble so formed. The temperatures of the resins from the two extruders are maintained such that the viscosity of the two streams is as close as possible at their meeting point. This temperature control is necessary to maintain the ratio of thickness between the foamed web (1) and the non-foamed web to a predetermined value in the laminated sheet formed therefrom.

Cooling is effected only on the inner side of the foamed layer (1) by means of cooling air from an air injector and typically is adjusted so that the inner surface of the foam layer is cooled more quickly than the outer surface of the laminate, the non-foamed cap layer (1).

The cooling bubble of coextruded foam is first cut open, then stretched longitudinally over a distance of roughly 30 ft. until is makes contact with heated pull rolls which transport the thus stretched and machine direction oriented product into a final winding station.

The particular foam formulation used in this invention is detailed in the following:

6 mils (0.15 mm)Foam, consisting of

8.5% Talc (supplied by Sekisui, Type MB)

90.5% GPPS Polystyrene Resin (Dow Styron 685D)

1% TiO₂ (5002 white PSC, supplied by PolyOne Corp., Avon Lake Ohio.)

Approximately 1.8 lbs./hr. of Butane is injected into the mix, but this material is ultimately lost in further processing and aging of the foam.

0.6 (0.015 mm) mils Solid, consisting of

50% High Temperature Polystyrene Crystal Resin (Dow Styron 685D)

50% High Impact Polystyrene (EB 6025 or alternatively KR03NW type K resin, both from Chevron Phillips Chemical Company)

It should be noted that this product is specially designed for metallization in that the skin (cap) layer which ordinarily contains fillers to enhance the whiteness and opacity of the stock is produced without fillers for metallization. Additionally, to enhance the adhesion of the metallized layer, the material was corona discharge treated prior to metallization.

As before mentioned, the foam itself provides a substantial portion of the insulative effects of the structure, but the inclusion of a metallized layer in the foam containing structure ads measurably to the overall insulative character of the packaging or labeling material.

### EXAMPLE 1

Water filled, 12 oz. aluminum beverage containers were cooled in a refrigerator to 38° F., then subjected to a free convection heating environment in bright sunlight, maintained at an ambient temperatures ranging from 80-90° F. in four separate tests. The heating rate for these containers was measured and the average heat transfer coefficient for free convection over the range measured was calculated. The average heat transfer coefficient so obtained was next measured for these same containers, but having an outer sheath of coextruded foam structure material made from a polystyrene core as described above and a compounded solid cap layer of high impact polystyrene as described above that is non-metallized and cover the outer walls of the container and has a thickness of 0.15 mm The following table shows the impact of the foam label:

| | Max. | Min. | Average Heat |
|---|---|---|---|
| | Temperature | Temperature | Transfer |
| | Differential | Differential | Coefficent |
| Test | ° F.* | ° F.** | Cal./min · ° C. · m² |
| 1 Control | 47.7 | 5 | 494 |
| 2 Control | 49.0 | 5 | 534 |
| 3 Control | 49.4 | 17.4 | 443 |
| 4 Control | 49.7 | 15.4 | 358 |
| Average Controls | | | 457 |
| 5 Unmet. Foam | 48.4 | 20.4 | 296 |
| 6. Unmet. Foam | 49.7 | 19.4 | 268 |
| Average | | | 282 |
| Unmet. Foam | | | |
| Average Reduction | | | 38% |

*maximum temperature difference at start of test between the fluid and ambient conditions
**minimum temperature difference at end of test between the fluid and ambient conditions

### EXAMPLE 2

Next, these same containers were compared to metallized foam labeled containers. In this instance the metallization was obtained by directly metalizing the outer skin layer of a previously corona treated foam sheet with aluminum. Corona treatment of the samples was done at Polymeric Converting, Enfield, Conn. The metalizing of the materials was done at Atlas Metalizing, New Britain, Conn. and the thickness of the metal layer was about 200 Å. The material was for all intents and purposes identical to the unmetallized sheet used in Example 1, except that the skin contained no TiO₂ filler, which is used to enhance the whiteness and opacity of the standard formula used for the coextruded foam. The formula used for the skin resin was 50% high impact polystyrene+50% clear, high temperature crystal polystyrene. This particular formula provided a measured gloss on the surface of the foam lamination of 55.4%, measured using a Trigloss Master sheen meter at 60° (produced by Sheen Instruments, LTD, Kingston Upon Thames, Richmond Rd., Surrey, England. The results under bright sunlight as described in Example 1 are shown in the following table:

| | Max. | Min. | Average Heat |
|---|---|---|---|
| | Temperature | Temperature | Transfer |
| | Differential | Differential | Coefficent |
| Test | ° F.* | ° F.** | Cal./min · ° C. · m² |
| 1 Control | 47.7 | 5 | 494 |
| 2 Control | 49.0 | 5 | 534 |
| 3 Control | 49.4 | 17.4 | 443 |
| 4 Control | 49.7 | 15.4 | 358 |
| Average Controls | | | 457 |
| 7. met. Foam | 41.3 | 16.1 | 241 |
| 8. | 49.7 | 20.4 | 254 |
| met. Foam | | | |
| Average met. Foam | | | 247.5 |
| Average Reduction | | | 45.8% |

*maximum temperature difference at start of test between the fluid and ambient conditions
**minimum temperature difference at end of test between the fluid and ambient conditions

### EXAMPLE 3

In this next example, the impact of the brightness of the metallized layer was evaluated. In this instance, the skin layer of the coextruded foam was modified by replacing the high impact polystyrene resin with “K resin” produced by Chevron Phillips Chemical Company. The particular resin used was the KR-03 grade, containing no wax ingredient. The gloss measured on the surface of this sample before metalizing with a layer of aluminum having a thickness of 200 Å, was 102.3%(Commodore Plastics test described earlier in Example 2). The results are shown in the following table:

| | Max. | Min. | Average Heat |
|---|---|---|---|
| | Temperature | Temperature | Transfer |
| | Differential | Differential | Coefficent |
| Test | ° F.* | ° F.** | Cal./min · ° C. · m² |
| 1 Control | 47.7 | 5 | 494 |
| 2 Control | 49.0 | 5 | 534 |
| 3 Control | 49.4 | 17.4 | 443 |
| 4 Control | 49.7 | 15.4 | 358 |
| Average Controls | | | 457 |
| 9 met. Foam | 41.3 | 17.1 | 225 |
| 10. met. Foam | 49.7 | 21.4 | 236 |
| Average met. Foam | | | 230.5 |
| Average Reduction | | | 49.6% |

*maximum temperature difference at start of test between the fluid and ambient conditions
**minimum temperature difference at end of test between the fluid and ambient conditions

### EXAMPLE 4

In addition to the tests of the direct metallized foam materials, tests were also run to determine the impact of the metallization on the insulative properties of transfer metallized foam stock. In this instance, the inside of the foamed layer of the coextruded stock was transfer metallized to provide a layer of aluminum 200 Å thick. The transfer metallization was done at Polymeric Converting, Enfield, Conn. The metallized layer took on the bright appearance typical of the basestock used for the transfer metallization, a coated polyester basestock. The gloss was not measured but the appearance to the eye was of the same order as that achieved by direct metallization of the K resin surface demonstrated in Example 3 above. The results under bright sunlight as described in Example 1 are shown in the following table:

| | Max. | Min. | Average Heat |
|---|---|---|---|
| | Temperature | Temperature | Transfer |
| | Differential | Differential | Coefficent |
| Test | ° F.* | ° F.** | Cal./min · ° C. · m² |
| 1 Control | 47.7 | 5 | 494 |
| 2 Control | 49.0 | 5 | 534 |
| 3 Control | 49.4 | 17.4 | 443 |
| 4 Control | 49.7 | 15.4 | 358 |
| Average Controls | | | 457 |
| 11. trans. met. Foam | 44.7 | 10.0 | 249 |
| 12. transmet. Foam | 45.4 | 21.4 | 253 |
| Average met. Foam | | | 251 |
| Average Reduction | | | 45.1% |

*maximum temperature difference at start of test between the fluid and ambient conditions
**minimum temperature difference at end of test between the fluid and ambient conditions

The surface of the foam layer of the stock was compressed somewhat during the transfer process and resultantly had some compressive wrinkles in the stock that likely had an impact upon the insulative properties of the stock. With some work to perfect the transfer process to eliminate this effect, the result from the transfer metallization is expected to be fully equivalent to that obtained with the direct metalizing of the stock demonstrated in Example 3.

Heat flow through a labeled container can be equated with the heat flow though a composite wall, constructed of different materials in layers. The thickness of the layers can be denoted as x1, x2, etc. and the thermal conductivity of the layers is k1, k2, etc. If the fluid on one side of the wall is at temperature TA, and the heat transfer coefficient from fluid to wall is aA, the temperature and heat transfer for the fluid on the other side of the wall are TB and aB. By using Fourier's law of conduction and Newton's law of cooling (in this instance used for heating), it can be shown that for steady state heat transfer that:

dQ/dt=U A (Tᵢₙ−Tₒᵤₜ),

where,

1/U=1/aA+1/aB+Summation (x/k)

We have shown that the high conductivity of aluminum, k=672,775 Cal./min.° C. m² makes the last term negligible, so that in effect the equation can be used similarly to the way that electrical resistance is used, and becomes:

1/U=1/aA+1/aB

Using this equation, the thermal resistance (reciprocal of the convection coefficient) provided by each of the insulation materials shown in the previous examples can be equated:

Unmetallized foam per Example 1: 1/U=1/aA+1/aB; 1/282=1/457+1/x 1/x=0.00135 min.° C. m²/cal.=r₁, the resistance of the unmetallized foam layer

Metallized foam having a matte finish, per Example 2: 1/247.5=1/457+r₂ r₂=0.00185 min.° C. m²/cal

Metallized foam having a high gloss finish, per Example 3; 1/230.5=1/457+r₃ r₃=0.00215 min.° C. m²/cal

What I claim is:

1. A packaging structure comprising at least one layer of a foam component and at least one metallized layer wherein the packaging structure enhances the insulating effect of the foam and provides a bright, attractive finish to a label or package

2. A packaging structure as defined in claim 1 where the foam component is a non-shrink foam.

3. A packaging structure as defined in claim 1, where the foam component is a shrinkable foam.

4. A packaging structure as defined in claim 1 where the foam component is derived from polystyrene, polystyrene copolymers, polypropylene, polypropylene copolymers polyethylene, polyethylene copolymers, polylactic-acid, polyethylene terephthalate, copolymers of polyethylene terephthalate, or a urethane.

5. A packaging structure which has an aluminum metal layer that is transfer metallized, or laminated to the foam component of said packaging structure.

4. A packaging structure as defined in claim 1 where the outer surface of the foam component is unmetallized foam and the foam component is formed by simultaneous extrusion of an un-foamed layer and a foamed layer, the un-foamed layer being adapted to adhere to a metallized layer.

5. A packaging structure as defined in claim 1 where the metallized layer has a print receiving layer.

6. A packaging structure as defined in claim 1 where the I layer has a transparent film laminated thereon which is reverse printed.

7. A packaging structure as defined in claim 1 where said foam layer has a laminated layer having on the outer surface reverse printing.

8. A packaging structure as defined in claim 1 where said foam component is in-line transfer metallized using a previously metallized donor web which is rewound and re-used as a metallization receptor prior to being laminated to said foam component.

9. A packaging structure as defined in claim 1 where a reverse printed film is laminated to a metallized foam component which has been in-line transfer metallized using a previously metallized donor web which is rewound and re-used as a metallization receptor.

10. A packaging structure as defined in claim 1 wherein a reverse printed film is in-line transfer metallized, prior to being laminated to a non-metallized foam

11. A packaging structure as defined in claim 9 where in a reverse printed film is in-line laminated to a transfer metallized foam layer, either through adhesive or extrusion lamination.

12. A method of making an insulating a beverage container, said method comprising providing a metallized foam and applying said metallized foam to the side wall of a beverage container.

13. A method as defined in claim 12 wherein the foam is a closed cell foam and said metallized layer has a reverse printed film applied on an outer surface.
